(19) United States
(12) Patent Application Publication
(10) Pub. No.: US 2015/0227342 A1
(43) Pub. Date: Aug. 13, 2015

(54) PRIORITIZE AND SORT FOR RECENTLY ADDED CONTACTS BASED ON TIME AND LOCATION

(71) Applicants: Martin Freund, Mountain View, CA (US); Momchil Filev, Mountain View, CA (US)

(72) Inventors: Martin Freund, Mountain View, CA (US); Momchil Filev, Mountain View, CA (US)

(21) Appl. No.: 13/589,498

(22) Filed: Aug. 20, 2012

Related U.S. Application Data
(60) Provisional application No. 61/666,809, filed on Jun. 30, 2012.

(51) Int. Cl. G06F 7/24

(52) U.S. Cl. CPC G06F 7/24

(57) ABSTRACT

A list of contacts in an electronic device may be sorted manually based on date when the contacts are added and/or location where the contacts are added. In this regard, contacts may be sorted and/or displayed in the order in which they were added—e.g., with the newest contacts on top, and/or in alphabetical order of the locations where the contacts were added. In some instances, the contacts may be prioritized (e.g., based on user input or commands) with certain number of contacts that are most recently added and/or were added in closest proximity to the current location of the electronic device or its user being listed or displayed on top.

### CLAIM OF PRIORITY

This patent application makes reference to, claims priority to and claims benefit from U.S. Provisional Patent Application Ser. No. 61/666,809, filed on Jun. 30, 2012.

The above stated application is hereby incorporated herein by reference in its entirety.

### TECHNICAL FIELD

Aspects of the present application relate to mobile devices. More specifically, certain implementations of the present disclosure relate to prioritize and sort for recently added contacts based on time and location.

### BACKGROUND

Various types of electronic devices are commonly used nowadays. In this regard, electronic devices are utilized by one or more users, for various purposes, both business and personal. Examples of such devices include personal computers, laptops, cellular phones, smartphones, tablets and the like. In this regard, some electronic devices may be hand-held and/or mobile; may support communication (wired and/or wireless); and may be general or special purpose devices. Because such mobile electronic devices may often be used on the move, data and/or information may be generated and/or updated during such use.

Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

Systems and methods are provided for prioritizing and sorting recently added contacts based on time and location, substantially as shown in and/or described in connection with at least one of the figures, as set forth more completely in the claims.

These and other advantages, aspects and novel features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 is a block diagram illustrating a mobile device that may be used in adding contacts at different locations and/or times.

FIG. 2 is a block diagram illustrating a mobile device that supports adaptive sorting and displaying of contacts.

FIGS. 3A-3B are block diagrams illustrating use of a mobile device for adaptively sorting contacts based on location and/or time.

FIG. 4 is a flow chart illustrating generation of contacts that allow for sorting based on location and/or time.

FIGS. 5A-5B are flow charts illustrating display of contacts based location and/or time of generation or update.

### DETAILED DESCRIPTION

The present disclosure relates to a method and system for prioritizing and sorting for recently added contacts based on time and location. In various implementations, an electronic device may enable adaptive sorting of contacts. In this regard, the electronic device may generate a contact entry, associate the contact entry with one or more attributes relating to the generation of the contact entry (e.g., time and/or location attributes), and subsequently select the generated contact entry during sorting and/or displaying of list of contact entries comprising the generated contact entry, based on the one or more attributes. The contact entry may be selected based on matching of the one or more attributes associated with the generated contact entry, with corresponding information obtained or generated by the electronic device. In this regard, the corresponding information may comprise one or both of current location and current time. The electronic device may prioritize the contact entry during the sorting and/or the displaying of the list of contact entries based on the matching of the one or more attributes associated with the generated contact entry with the corresponding information. In some instances, the electronic device may allow for an acceptable variation between the corresponding information and the one or more attributes associated with the generated contact entry during the matching. For example, the acceptable variation may correspond to distance from current location that may still result in success location based matching. The acceptable variation may be configurable.

The electronic device may automatically prioritize a particular number of contact entries during any sorting and/or displaying of the list of contact entries based on at least some of the one or more attributes associated with each contact entry. In this regard, the prioritized contact entries may be selected based on one or both of particular time and particular location. The electronic device sorts the list of contact entries based on user input specifying information for controlling prioritizing contact entries, based on at least some of the one or more attributes associated with each of the list of contact entries. In this regard, the specified information may comprise one or both of particular time and particular location. For example, the user may specify that the contacts be sorted based on particular locational criteria, such that contact(s) relating to particular location (e.g., home/work address or place where contact(s) were added or modified match particular location) may be displayed first. Similarly, the user may specify that the contacts be sorted based on particular chronological criteria, such that more recently added or modified contacts are displayed first for example.

As utilized herein the terms “circuits” and “circuitry” refer to physical electronic components (i.e., hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “exemplary” means serving as a non-limiting example, instance, or illustration. As utilized herein, the term “e.g.,” introduces a list of one or more non-limiting examples, instances, or illustrations.

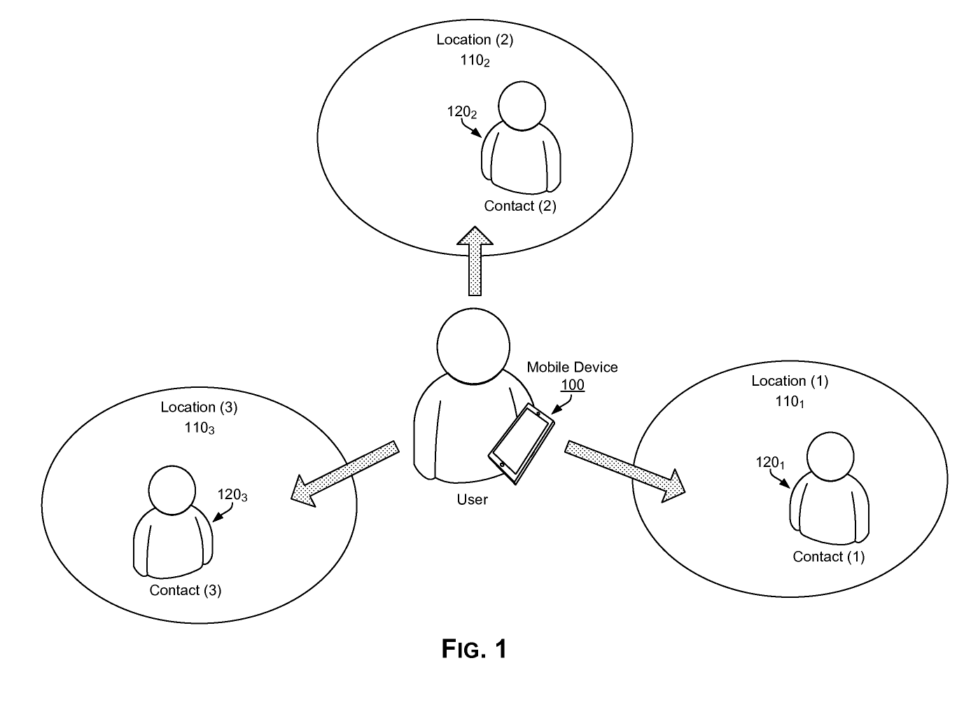

FIG. 1 is a block diagram illustrating a mobile device that may be used in adding contacts at different locations and/or times. Referring to FIG. 1 there is shown a mobile device 100.

The mobile device 100 may comprise suitable logic, circuitry, interfaces, and/or code that may be operable to perform various functions, and/or run various applications and/or programs. In this regard, functions, applications and/or programs supported by the mobile device 100 may be executed and/or run based on user instructions and/or pre-configured instructions. In some instances, the mobile device 100 may support communication of data, via wired and/or wireless connections, in accordance with one or more supported wireless and/or wired protocols or standards. The mobile device 100 may be readily moved, such as when a user of the mobile device 100 is moving, and the mobile device 100 may support operations on the move. Examples of such mobile devices may comprise cellular phones, smartphones, tablets, laptop computers, desktop or personal computers, televisions, personal media players, and/or other similar devices. The disclosure, however, is not limited to any particular type of mobile devices.

In operation, the mobile device 100 may be utilized (e.g., by its user) to perform, execute, or run various tasks and/or applications. In this regard, some of the tasks and/or applications performed, executed, or run by the mobile device 100 may be done on the move—i.e., at different locations. The mobile device 100 may be used to, for instance, generate and/or update contacts related information. For example, the user of the mobile device 100 may utilize the mobile device 100 to generate and/or update contact information associated with a first contact (120₁) at a first location (110₁); to generate and/or update contact information associated with a second contact (120₂) at a second location (110₂); and to generate and/or update contact information associated with a third contact (120₃) at a third location (110₃). Furthermore, the contacts information associated with the different contacts (120₁, 120₂, and 120₃) may be generated at different times. For example, a user of the mobile device 100 may travel first to the first location 110₁, whereby the contacts information associated with the first contact 120₁ may be generated and/or updated; then subsequently (after some time) may travel to the second location 110₂, whereby the contacts information associated with the second contact 120₂ may be generated and/or updated; then (after some time) may travel to the third location 110₃, whereby the contacts information associated with the third contact 120₃ may be generated and/or updated. In most mobile devices currently in use, displaying contacts information is typically based on some form of alphabetical sorting (e.g., in ascending or descending order, based on the first letter in the first or last name of the contact). Such alphabetical-based sorting, however, may make it difficult to find a recently added contact (e.g., met at a recent event), or to find a particular contact based on the location where the contact(s) may have been added such as when the user subsequently is at or near that location.

In various implementations, the sorting and/or displaying of contacts information in mobile devices, such as the mobile device 100, may be modified to allow for adaptive sorting and/or prioritization (e.g., when displaying the contacts information) based on particular criteria, such as time and/or location of creation or update of the contacts information. In this regard, rather than simply sorting contacts (e.g., for display) based on limited criteria (e.g., alphabetically), particular contacts may be prioritized based on other factors, such as location and/or time, in a manner that allow listing contacts that are more likely to be relevant to the user. For example, in instances where the user of mobile device 100 may return to location 110₁, subsequent to the creation of contact 120₁, the user may desire to have the contacts displayed in the mobile device 100 such that all contact(s) added when the user was there (including contact 120₁) may be displayed first. This may be achieved by prioritizing, when contacts are being sorted for display thereof, those contacts that were created (or updated) at or near location 110₁. For example, in such location-based sorting, contacts with creation/update locations that may match or may sufficiently be near current location of the mobile device 100 may be prioritized. In time based sorting, the contacts with creation/update locations that may be deemed as recent relative to current time (of the mobile device 100) may be prioritized. For instance, in the example given above, the contacts available in the mobile device 100 (e.g., contacts 120₁, 120₂, and 120₃), may be sorted. These contacts may be the most recent contacts created or updated in the mobile device 100, and thus may be prioritized and displayed at the top of the list of the contacts irrespective of where they would have been placed on an alphabetical basis.

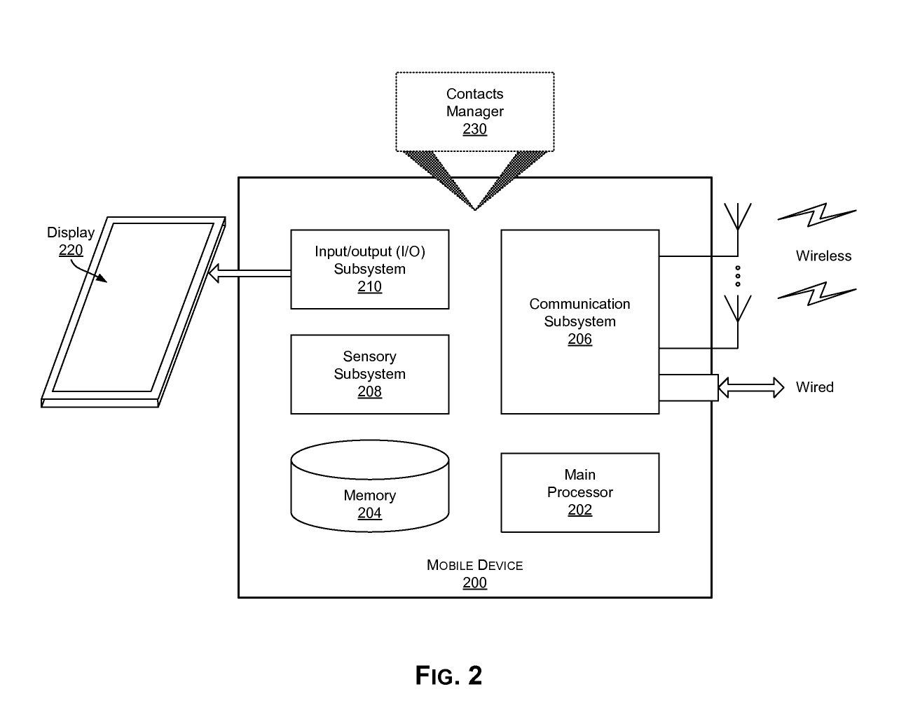

FIG. 2 is a block diagram illustrating a mobile device that supports adaptive sorting and displaying of contacts. Referring to FIG. 2, there is shown a mobile device 200.

The mobile device 200 may comprise suitable logic, circuitry, interfaces, and/or code that may be operable to implement various aspects of the disclosure. In this regard, the mobile device 200 may correspond to the mobile device 100 of FIG. 1. The mobile device 200 may comprise, for example, a main processor 202, a system memory 204, a communication subsystem 206, a sensory and input/output (I/O) subsystem 208, an input/output (I/O) subsystem 210, and a display 220.

The main processor 202 may comprise suitable logic, circuitry, interfaces, and/or code that may be operable to process data, and/or control and/or manage operations of the mobile device 200, and/or tasks and/or applications performed therein. In this regard, the main processor 202 may be operable to configure and/or control operations of various components and/or subsystems of the mobile device 200, by utilizing, for example, one or more control signals. The main processor 202 may enable running and/or execution of applications, programs and/or code, which may be stored, for example, in the system memory 204. Alternatively, one or more dedicated application processors may be utilized for running and/or executing applications (or programs) in the mobile device 200. In some instances, some of the applications running and/or executing on the mobile device 200 may generate and/or update video content that may be rendered via the display 220.

The system memory 204 may comprise suitable logic, circuitry, interfaces, and/or code that may enable permanent and/or non-permanent storage, buffering, and/or fetching of data, code and/or other information, which may be used, consumed, and/or processed. In this regard, the system memory 204 may comprise different memory technologies, including, for example, read-only memory (ROM), random access memory (RAM), Flash memory, solid-state drive (SSD), and/or field-programmable gate array (FPGA). The system memory 204 may store, for example, configuration data, which may comprise parameters and/or code, comprising software and/or firmware.

The communication subsystem 206 may comprise suitable logic, circuitry, interfaces, and/or code operable to communicate data from and/or to the mobile device, such as via one or more wired and/or wireless connections. The communication subsystem 206 may be configured to support one or more wired protocols (e.g. Ethernet standards) and/or wireless protocols or interfaces (e.g., Bluetooth, WiFi, cellular, WiMAX, and/or any available wireless protocol/interface), facilitating transmission and/or reception of signals to and/or from the mobile device 200, and/or processing of transmitted or received signals in accordance with applicable wired or wireless protocols. In this regard, signal processing operations may comprise filtering, amplification, analog-to-digital conversion and/or digital-to-analog conversion, up-conversion/down-conversion of baseband signals, encoding/decoding, encryption/decryption, and/or modulation/demodulation.

The sensory subsystem 208 may comprise suitable logic, circuitry, interfaces, and/or code for obtaining and/or generating sensory information, which may relate to the mobile device 200, its user(s), and/or its environment. For example, the sensory and I/O subsystem 208 may comprise positional or locational sensors (e.g., GPS or other GNSS based sensors), ambient conditions (e.g., temperature, humidity, or light) sensors, and/or motion related sensors (e.g., accelerometer, gyroscope, pedometers, and/or altimeters).

The I/O subsystem 210 may comprise suitable logic, circuitry, interfaces, and/or code for enabling user interactions with the mobile device 200, enabling obtaining input from user(s) and/or to providing output to the user(s). The I/O subsystem 210 may support various types of inputs and/or outputs, including, for example, video, audio, and/or textual. In this regard, dedicated I/O devices and/or components, external to or integrated within the mobile device 200, may be utilized for inputting and/or outputting data during operations of the I/O subsystem 210. Exemplary I/O devices may comprise displays, mice, keyboards, touchscreens, and the like. With respect to video outputs, the I/O subsystem 210 may be operable to generate and/or process video content, graphics, and/or textual data, and/or generating video frames based thereon for display, via the display 220 for example.

The display 220 may comprise suitable logic, circuitry, interfaces and/or code that may enable displaying of video content, which may be handled and/or processed via the I/O subsystem 210. The display 220 may be used in outputting video data, which may comprise contacts lists.

In some instances, mobile device 200 may comprise a contacts manager 230. In this regard, the contacts manager 230 may comprise suitable logic, circuitry, interfaces and/or code for managing contacts and/or handling or use of contacts-related information in the mobile device 200. In some implementations, the contacts manager 230 may be operable to support adaptive sorting and/or prioritization of contacts information (e.g., in conjunction with displaying of contacts information), based on particular criteria, such as time and/or location of creation or update of the contacts information. The contacts manager 230 may be implemented as software component (function), such as within an operating system (OS) running in the mobile device 200. Alternatively, contacts manager 230 may comprise a dedicated hardware and/or software component of the mobile device 200.

In operation, the mobile device 200 may be utilized (e.g., by its user) to perform, execute, or run various tasks and/or applications, which may include, for example, generating and/or updating contacts that may be relevant to the device user. In this regard, contacts may refer to persons or non-persons (e.g., businesses), and may comprise various types, including, but not limited to, phone (landline and/or mobile) contacts, email contacts, mailing contacts, social networking contacts, and the like. The disclosure, however, is not limited to any particular type of contacts. The mobile device 200 may maintain, such as via the contacts manager contacts related information. For example, contact related information may comprise contact identification information (e.g., name or similar identifiers), and/or information relating to means for communicating with the contacts (e.g., phone number, email address, online identifiers, etc.). As explained above, most contemporary mobile devices may allow for displaying contacts based on some limited basis, typically based on some form of alphabetical sorting (e.g., in ascending or descending order, based on the first letter in the first or last name of the contact). Such alphabetical based sorting, however, may make it hard to readily find a recently added contact and/or or a particular contact that is relevant to a particular location.

Accordingly, in various implementations, the sorting and/or displaying of contacts information in the mobile device 200 may be modified to allow for adaptive sorting and/or prioritization (e.g., when displaying the contacts information) based on particular criteria, such as time and/or location of creation or update of the contacts information. In this regard, rather than simply sorting contacts (e.g., for display) based on limited criteria (e.g., alphabetically), the contacts manager 230 may identify and/or prioritize particular contacts based on particular additional factors, such as location and/or time, in a manner that may allow for adaptively listing contacts such that contacts that may be more relevant to the user would display ahead of other contacts, regardless of the alphabetical order of the contacts.

For example, in an implementation, contacts (of any type) may be manually sorted (i.e., based on user input, obtained via the I/O subsystem 210 for example) by date added or updated. In this regard, contacts may be prioritized such that they may be listed in the order (time-wise) in which the contacts were added (with the newest contacts on top). For example, whenever a contact is generated or updated, the current time may be recorded (e.g., via the sensory subsystem 208), and a data stamp showing the date/time in which the contact was added/updated may be created and incorporated into the contacts related information. These data stamps may subsequently be used in controlling and/or adjusting listings of contacts. For example, the data stamps may subsequently be used to identify and prioritize the more recent contacts, by comparing the contacts' data stamps with current time when listing of contacts is requested.

In an implementation, contacts (of any type) may be manually sorted (i.e., based on user input, obtained via the I/O subsystem 210 for example) by location added or updated. In this regard, contacts may be prioritized such that they may be listed in the order corresponding to the location(s) where the contacts were added (with the newest contacts on top). For example, whenever a contact is generated or updated, the current location may be recorded (e.g., via the sensory subsystem 208, such as using GNSS information), and location stamp showing the location at which the contact was added/updated may be created and incorporated into the contacts related information. The location stamps may also include location associated with the contact beyond simply the location where the contact where added or modified. For example, the location stamps may also comprise other pertinent location information associated with the contacts, such as home or work address, or the like. The location stamps may subsequently be used in controlling and/or adjusting listings of contacts. For example, during location based sorting, the contacts may be grouped based on information in their corresponding location stamps (e.g., locations of where they were added and/or updated), and then may be listed in alphabetical order of the locations (e.g., Chicago based contacts first, and then Dallas based contacts, than Phoenix based contacts, etc.). Alternatively, whenever location based listing of contacts is requested, the current location of the mobile device 200 may be determined, and the current location may be compared (e.g., via the contacts manager 230) with the location stamps of the contact to locate contacts corresponding to (or near) the current location. For example, where the current location of the mobile device 200 is determined to be Los Angeles, the contact sorting may be performed in location based manner such that contacts whose location stamps comprise “Los Angeles” (e.g., as location where the contacts where added or last modified), may be prioritized and thus display first. Furthermore, the contacts manager 230 may control aspects of such location based sorting. For example, the contacts manager 230 may adjust the range of acceptable matching (e.g., varying the size or characteristics of area around the current location, which any contacted added/updated in it would qualify as positive match for current location).

In an implementation, the mobile device 200 may be configured (e.g., via the contacts manager 230) to automatically—i.e., without requiring user input—prioritize and list a particular number of contacts (e.g., 3-5) which may be determined to be the most recently added/updated contacts on top of any listing of contacts, with the remaining contacts in the listing being sorted in accordance with traditional basis (e.g., alphabetical).

In an implementation, the mobile device 200 may be configured (e.g., via the contacts manager 230) to automatically—i.e., without requiring user input—prioritize and list a particular number of contacts (e.g., 3-5) which may be determined to be closest added/updated contacts to the current location of the mobile device 200 on top of any listing of contacts, with the remaining contacts in the listing being sorted in accordance with traditional basis (e.g., alphabetical).

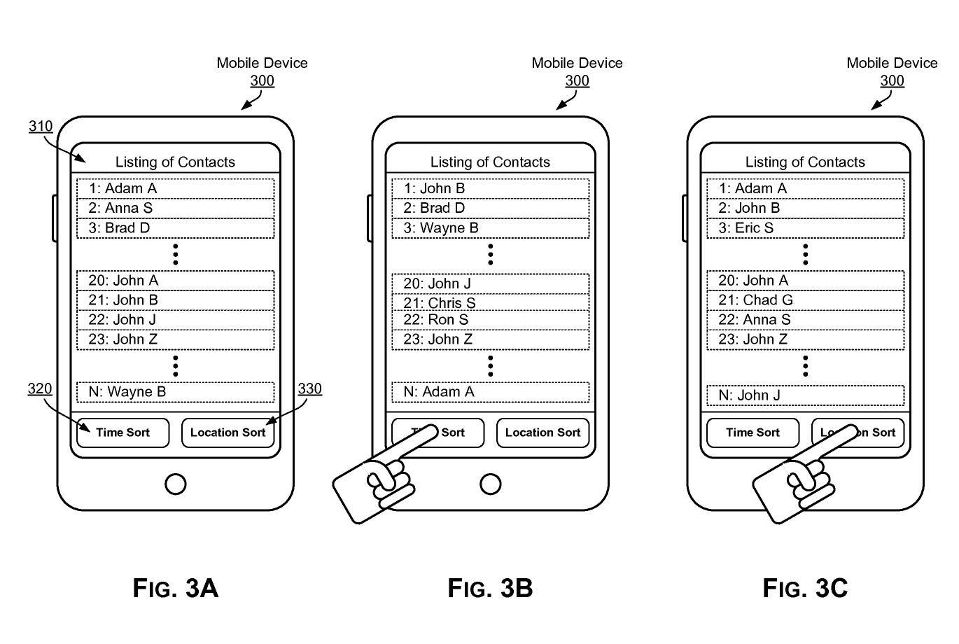

FIGS. 3A-3B are block diagrams illustrating use of a mobile device for adaptively sorting contacts based on location and/or time. Referring to FIGS. 3A-3B, there is shown a mobile device 300, which may be operable to provide adaptive sorting and/or prioritization of contacts information. The mobile device 300 may be, for example, substantially similar to the mobile device 200, as described with respect to FIG. 2, for example.

As shown in FIG. 3A, the mobile device 300 may be used to display a listing of contacts (310) stored therein. In this regard, as shown in FIG. 3A, the list of contacts 310 may typically be an alphabetical based listing, whereby existing contacts information may be sorted alphabetically, using ascending or descending order, based on, for example, the first letter in the first name then based on the first letter of the last name of the contact.

In some implementations, however, the listing of contacts may be modified to allow for adaptive sorting and/or displaying based thereon, such as using location and/or time related information. In this regard, the listing of contacts function in the mobile device 300 may incorporate interactive measures for allowing the user to specify non-typical, adaptive listing of contacts. For example, the contacts interface displayed via the mobile device 300 (via its screen), may incorporate touchscreen buttons, 320 and 330, for allowing the user to request time based sort and location based sort, respectively.

In FIG. 3B, upon user input (e.g., by pressing touchscreen button 320), the listing of contacts 310 may be re-displayed after re-sorting of the contacts based on time, such as in accordance with time of generation (or update), with the most recently generated or updated contacts being displayed at the top of the list. This may result in a listing of contacts that may differ from an alphabetical sorting based display. In other words, contacts information available in the mobile device 300 may be sorted, in ascending or descending order, based on how recently the contacts were added or updated.

In FIG. 3C, upon user input (e.g., by pressing touchscreen button 330), the listing of contacts 310 may be re-displayed after re-sorting of the contacts based on location, such as based on comparing (or matching) the current location of the mobile device 300 with location(s) of generation (or update) of the contacts, with the contacts that were generated or updated closest to the current location being displayed at the top of the list. This may result in a listing of contacts that may differ from alphabetical based (or time based) sorting. In other words, contacts information available in the mobile device 300 may be sorted, in ascending or descending order, based on distance between the current location of the mobile device 300 and the location(s) where the contacts were added or updated.

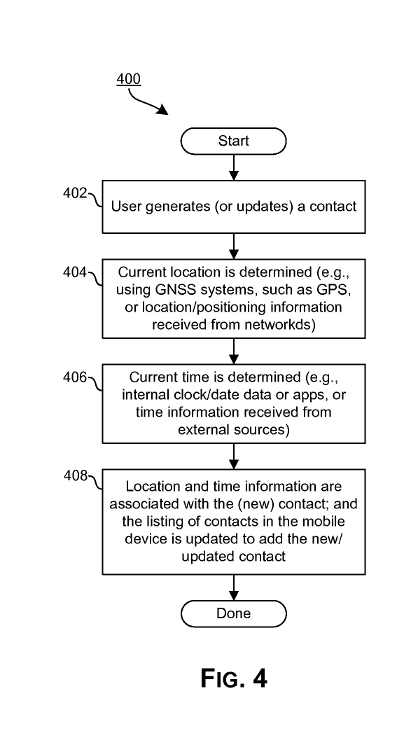

FIG. 4 is a flow chart illustrating generation of contacts that allow for sorting based on location and/or time. Referring to FIG. 4, there is shown a flow chart 400 comprising a plurality of exemplary steps for generating (or updating) contacts in a manner that may allow for subsequent sorting and/or displaying of contacts based on location and/or time.

In step 402, a user of a mobile device (e.g., user of mobile device 200) may generate (or update) a contact. In step 404, a current location associated with the mobile device, and corresponding to where the contact is generated or updated, may be determined. In this regard, current location may be determined based on, for example, location information, which may be obtained from a global navigational system (e.g., GNSS systems) and/or based on location/positional information obtained from networks with which the mobile device may communication (e.g., WiFi or cellular networks, etc.). The disclosure, however, is not limited to any particular means for determining current location. In step 406, a current time associated with the mobile device, and corresponding to when the contact is generated or updated, may be determined. In this regard, current time may be determined based on internal data (e.g., internal clock and/or calendar tracking functions or applications), and/or based on time information received from external sources, such as from networks with which the mobile device may communication (e.g., WiFi or cellular networks, etc.) or from broadcasts (e.g., radio or TV, GNSS systems, etc.) received via the mobile device. In step 408, the current location and/or time information (e.g., as determined in steps 404 and 406) may be associated with the newly generated or updated contact. Furthermore, any listing(s) of contacts in the mobile device may be updated to incorporate the newly generated or updated contact.

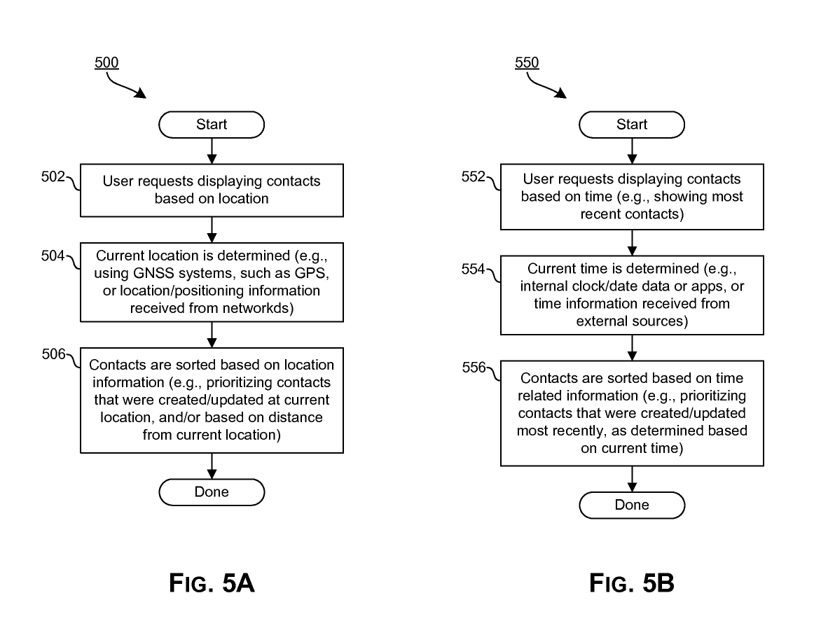

FIGS. 5A-5B are flow charts illustrating display of contacts based location and/or time of generation or update. Referring to FIGS. 5A-5B, there are shown flow charts 500 and 550, each of which comprising a plurality of exemplary steps for displaying contacts based on location or time of generation or update of contacts.

With regard to flow chart 500, in step 502, a user of a mobile device (e.g., a user of mobile device 300) may request displaying contacts based on location. For example, the user may input this request by clicking the “Location Sort” touchscreen button 330. In step 504, current location associated with the mobile device may be determined. In this regard, the current location may be determined based on, for example, location information, which may be obtained from external sources, such as global navigational systems (e.g., GNSS systems) and/or from networks with which the mobile device may communication (e.g., WiFi or cellular networks, etc.). In step 506, contacts whose information may be maintained in the mobile device may be sorted based on location information. For example, contacts which may have been created and/or updated at or near the determined current location may be prioritized. Accordingly, the contacts may be displayed in location based order, such as in ascending or descending order, based on distance from current position.

With regard to flow chart 550, in step 552 a user of a mobile device (e.g., a user of mobile device 300) may request displaying contacts based on time. For example, the user may input this request by clicking the “Time Sort” touchscreen button 320. In step 554, current time associated with the mobile device may be determined. In this regard, the current time may be determined based on, for example, internal time related data (e.g., using internal clock and/or calendar tracking functions or applications), and/or based on time related information received from external sources, such as from networks with which the mobile device may communication (e.g., WiFi or cellular networks, etc.) or from broadcasts (e.g., radio or TV. GNSS systems, etc.). In step 556, contacts whose information may be maintained in the mobile device may be sorted based on time related information. For example, most recently created and/or updated contacts, compared to the determined current time, may be prioritized. Accordingly, the contacts may be displayed in time based order, such as in ascending or descending order, based on most recent creation or update.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for prioritize and sort for recently added contacts based on time and location.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a non-transitory (i.e., not purely signal-based) computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

1. A method comprising:
in an electronic device:
generating a contact entry;
determining a location of the electronic device corresponding to where the contact entry was generated;
associating the generated contact entry with one or more attributes relating to the generation of the contact entry, the one or more attributes comprising at least the determined location; and
selecting the generated contact entry during sorting and/or displaying of a plurality of contact entries comprising the generated contact entry, based on the one or more attributes.

2. The method of claim 1, further comprising:
determining a time corresponding to when the contact entry was generated, wherein the one or more attributes further comprise at least the determined time.

3. (canceled)

4. The method of claim 1, further comprising; selecting the generated contact entry based on matching of the one or more attributes associated with the generated contact entry with corresponding attributes obtained or generated by the electronic device.

5. The method of claim 4, wherein the corresponding attributes comprise one or both of current location of the electronic device and current time.

6. The method of claim 4, further comprising prioritizing the generated contact entry during the sorting and/or the displaying of the plurality of contact entries based on the matching of the one or more attributes associated with the generated contact entry with the corresponding attributes.

7. The method of claim 4, further comprising allowing for an acceptable variation between the corresponding attributes and the one or more attributes associated with the generated contact entry during the matching.

8. The method of claim 7, wherein the acceptable variation is configurable.

9. The method of claim 1, further comprising automatically prioritizing a particular number of contact entries during any sorting and/or displaying of the plurality of contact entries based on at least some of the one or more attributes associated with each generated contact entry.

10. The method of claim 9, further comprising selecting the prioritized contact entries based on one or both of particular time and particular location of the electronic device.

11. The method of claim 1, further comprising sorting the plurality of contact entries based on user input specifying information for controlling prioritizing contact entries based on at least some of the one or more attributes associated with each of the plurality of contact entries.

12. The method of claim 11, wherein the information comprises one or both of particular time and particular location of the electronic device.

13. A system, comprising:
an electronic device, the electronic device being operable to:
generate a contact entry;
determine a location of the electronic device corresponding to where the contact entry was generated;
associate the generated contact entry with one or more attributes relating to the generation of the contact entry, the one or more attributes comprising at least the determined location one of time-related attributes and location-related attributes; and
select the generated contact entry during sorting and/or displaying of a plurality of contact entries comprising the generated contact entry, based on the one or more attributes.

14. The system of claim 13, wherein the electronic device is operable to determine a time corresponding to when the contact entry was generated, wherein the one or more attributes further comprise at least the determined time wherein the time.

15. (canceled)

16. The system of claim 13, wherein the electronic device is operable to select the generated contact entry based on matching of the one or more attributes associated with the generated contact entry, with corresponding attributes obtained or generated by the electronic device.

17. The system of claim 16, wherein the corresponding attributes comprise one or both of current location of the electronic device and current time.

18. The system of claim 16, wherein the electronic device is operable to prioritize the generated contact entry during the sorting and/or the displaying of the plurality of contact entries based on the matching of the one or more attributes associated with the generated contact entry with the corresponding attributes.

19. The system of claim 16, wherein the electronic device is operable to allow for an acceptable variation between the corresponding attributes and the one or more attributes associated with the generated contact entry during the matching.

20. The system of claim 19, wherein the acceptable variation is configurable.

21. The system of claim 13, wherein the electronic device is operable to automatically prioritize a particular number of contact entries during any sorting and/or displaying of the plurality of contact entries based on at least some of the one or more attributes associated with each generated contact entry.

22. The system of claim 21, wherein the electronic device is operable to select the prioritized contact entries based on one or both of particular time and particular location of the electronic device.

23. The system of claim 13, wherein the electronic device is operable to sort the plurality of contact entries based on user input specifying information for controlling prioritizing contact entries based on at least some of the one or more attributes associated with each of the plurality of contact entries.

24. The system of claim 23, wherein the information comprises one or both of particular time and particular location of the electronic device.

25. A non-transitory machine-readable storage medium having stored thereon, a computer program having at least one code section for managing contact information of a mobile device, the at least one code section being executable by a machine for causing the machine to perform steps, comprising:
generating a contact entry;
determining a location of the electronic device corresponding to where the contact entry was generated;
associating the generated contact entry with one or more attributes relating to the generation of the contact entry, the one or more attributes comprising at least the determined location one of time-related attributes and location-related attributes; and
selecting the generated contact entry during sorting and/or displaying of a plurality of contact entries comprising the generated contact entry, based on the one or more attributes.

26. The non-transitory machine-readable storage of claim 25, wherein the at least one code section comprises code for determining a time corresponding to when the contact entry was generated, wherein the one or more attributes further comprise at least the determined time.

27. (canceled)

28. The non-transitory machine-readable storage of claim 25, wherein the at least one code section comprises code for automatically prioritizing a particular number of contact entries during any sorting and/or displaying of the plurality of contact entries based on at least some of the one or more attributes associated with each generated contact entry.

29. A system, comprising:
an electronic device, the electronic device being operable to:
determine a current location of the electronic device;
sort a plurality of contact entries maintained in the electronic device based on the determined current location, wherein:
one or more of the plurality of contact entries are associated with attribute information identifying respective locations where each of the one or more of the plurality of contact entries was generated or last updated; and
the sorting comprises prioritizing at least some of the one or more of the plurality of contact entries based on proximity of the location identified in the corresponding attribute information to the current location.

30. The system of claim 29, wherein the electronic device is operable to display the plurality of contact entries based on the sorting, wherein the at least some of the one or more of the plurality of contact entries are displayed as prioritized.
